(19) United States
(12) Patent Application Publication
(10) Pub. No.: US 2014/0223122 A1
(43) Pub. Date: Aug. 7, 2014

(54) MANAGING VIRTUAL MACHINE PLACEMENT IN A VIRTUALIZED COMPUTING ENVIRONMENT

(71) Applicant: INTERNATIONAL BUSINESS MACHINES CORPORATION, Armonk, NY (US)

(72) Inventors: Ali R. Butt, Blacksburg, VA (US); Kavita Chavda, Roswell, GA (US); Min Li, Blacksburg, VA (US); Pin Zhou, San Jose, CA (US)

(73) Assignee: INTERNATIONAL BUSINESS MACHINES CORPORATION, Armonk, NY (US)

(21) Appl. No.: 13/760,113

(22) Filed: Feb. 6, 2013

(51) Int. Cl. G06F 3/06

(52) U.S. Cl. CPC G06F 3/0655
USPC 711/162

(57) ABSTRACT

A method for determining that first and second virtual machines, that currently execute in first and second host computing systems, respectively, should both execute within a same host computing system. The method includes determining that the first and second virtual machines have accessed same data more often than a third and fourth virtual machines have accessed said same data. Based in part on this determination, the method includes determining that the first and second virtual machines should execute in a same host computing system having a same cache memory for both the first and second virtual machines and that the third and fourth virtual machines should execute on one or more different host computing systems than said same host computing system.

### FIELD OF THE INVENTION

The present invention relates generally to the field of virtualized computing environments, and more particularly to managing virtual machine placement in a virtualized computing environment.

### BACKGROUND OF THE INVENTION

Virtualization is a core component for servers, cloud computing and virtual desktop environments (VDE) and is often used in data centers because it allows a great deal of flexibility in the provisioning and placement of servers and their associated workloads in the data center. In system virtualization, multiple virtual computing systems or virtual machines are created within a single physical computing system. The physical system can be a stand-alone computer, or alternatively, a computing system utilizing clustered computers and components. Virtual systems, or virtual machines, are independent operating environments that use logical or real divisions of physical resources such as processors, memory, and input/output (I/O) adapters. System virtualization is implemented through some managing functionality, typically hypervisor technology. Hypervisors, also called virtual machine managers (VMMs), use a thin layer of code in software or firmware to achieve fine-grained, dynamic resource sharing. Hypervisors are the primary technology for system virtualization because they provide the greatest level of flexibility in how virtual resources are defined and managed.

Hypervisors provide the ability to divide physical computing system resources into isolated logical partitions. Logical partitioning is the ability to logically divide a real, or physical, server into two or more independent servers, and one or more applications execute in each virtual machine or logical partition as if the virtual machine or logical partition was a separate physical computer. Each logical partition, also called a virtual system, virtual server, or virtual machine, operates like an independent computing system running its own operating system. Operating systems running in a virtualized computing environment are often referred to as “guest machines.” Hypervisors can allocate dedicated processors, I/O adapters, and memory to each virtual machine and can also allocate shared processors to each virtual machine. In some manners of virtualization, the hypervisor creates a shared processor pool from which the hypervisor allocates time slices of virtual processors to the virtual machines according to predetermined allocation percentages. In other words, the hypervisor creates virtual processors from physical processors so that virtual machines can share the physical processors, which includes sharing cache space and memory bandwidth, while running independent operating environments.

In addition to creating and managing the virtual machines, the hypervisor manages communication between the virtual machines via a virtual network. To facilitate communication, each virtual machine may have a virtual adapter for communication between the virtual machines, via the virtual network and with other computing or storage devices within a computing system via a real network. The type of the virtual adapter depends on the operating system used by the virtual machine. Examples of virtual adapters include virtual Ethernet adapters, virtual Fibre Channel adapters, virtual Small Computer Serial Interface (SCSI) adapters, and virtual serial adapters.

U.S. Pat. No. 8,099,487 by Smirnov discloses a method to use performance measurements made on a virtualized system to determine or suggest how to rearrange virtual machines and their associated workloads to provide improved resource utilization in the system. The performance measurements evaluated can be CPU utilization, memory utilization, network bandwidth, or I/O storage bandwidth. U.S. Pat. No. 8,099,487 by Smirnov uses techniques that may include summing the selected performance values, computing standard deviations or other statistical measures to determine a balance, or aggregation, of the selected performance values to determine an advantageous placement or movement of virtual machines in a virtualized computing environment under the control of a virtualization manager.

US Publication 2011/0225277 by Freimuth discloses a method for managing server placement of virtual machines in an operating environment. The method enables placement of virtual machines (VMs) while minimizing, at the same time, both the server and the network cost. US Publication 2011/0225277 by Freimuth includes determining a mapping of each virtual machine in a plurality of virtual machines to at least one server in a set of servers, where the mapping substantially satisfies a set of primary constraints associated with the set of servers.

### SUMMARY

Embodiments of the present invention disclose a method, computer program product, and computer system for determining that first and second virtual machines, that currently execute in first and second host computing systems, respectively, should both execute within a same host computing system. The method includes determining that the first and second virtual machines have accessed same data more often than a third and fourth virtual machines have accessed said same data, and based in part on the determination, determining that the first and second virtual machines should execute in a same host computing system having a same cache memory for both the first and second virtual machines and that the third and fourth virtual machines should execute on one or more different host computing systems than said same host computing system.

### BRIEF DESCRIPTION OF THE SEVERAL VIEWS OF THE DRAWINGS

FIG. 1 illustrates a virtualized computing environment, in accordance with an embodiment of the present invention.

FIG. 2 is a flowchart illustrating operational steps of a grouping and migration program, residing on a server computer, for grouping virtual machines and migrating the grouped virtual machines within the virtualized computing environment of FIG. 1, in accordance with an embodiment of the present invention.

FIG. 3 depicts migration of virtual machines within a virtualized computing environment based on operation of the grouping and migration program of FIG. 2, in accordance with an embodiment of the present invention.

FIG. 4 depicts a block diagram of internal and external components of a data processing system, such as the host computing system or the server computer of FIG. 1, in accordance with an embodiment of the present invention.

### DETAILED DESCRIPTION

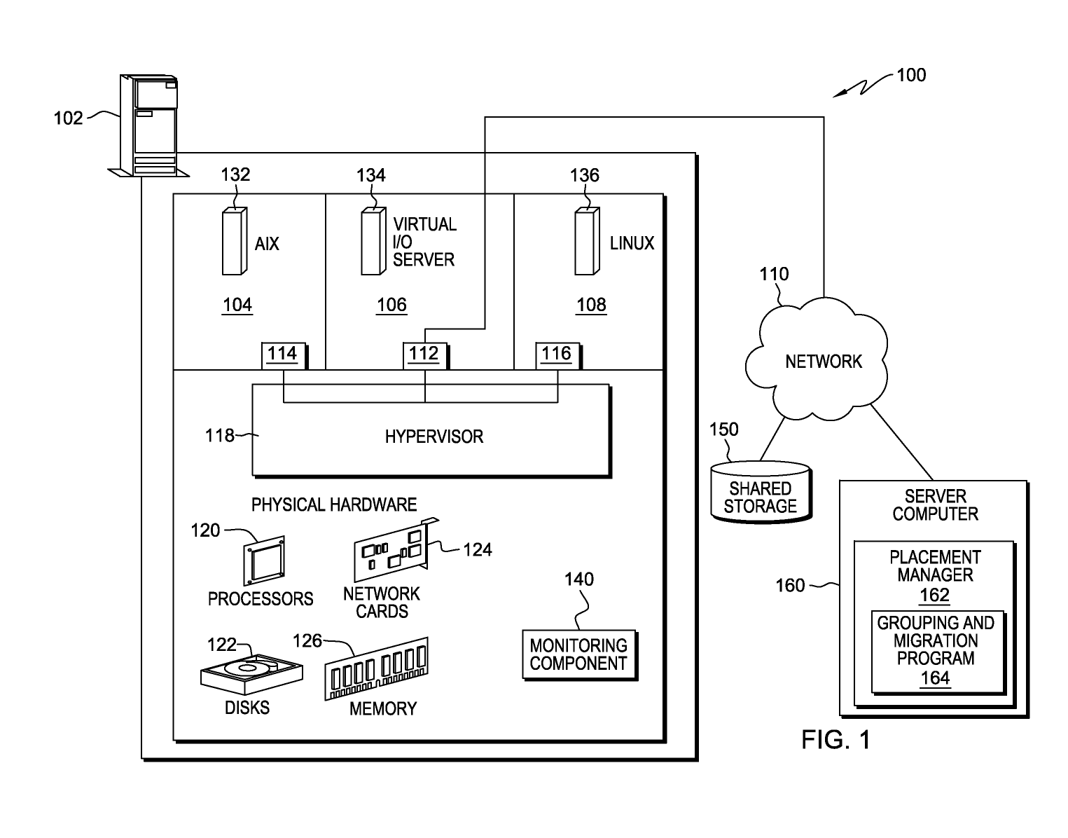

The present invention will now be described in detail with reference to the Figures. FIG. 1 illustrates a virtualized computing environment, generally designated 100, in accordance with an embodiment of the present invention.

Virtualized computing environment 100 includes at least one host computing system, such as host computing system 102, shared storage 150, and server computer 160, all interconnected via network 110. Host computing system 102 is a physical computing system, and is capable of executing machine-readable instructions. In a preferred embodiment of the present invention, host computing system 102 is capable of hosting multiple virtual machines (also called virtual servers or logical partitions), and of communicating via network 110 with other host computing systems, computing devices and/or storage devices within virtualized computing environment 100, for example, as in a virtual desktop environment (VDE). In various embodiments of the present invention, host computing system 102 can represent a computing system utilizing clustered computers and components to act as a single pool of seamless resources when accessed through a network, such as network 110. Host computing system 102 can be used in data centers and for cloud computing applications.

Host computing system 102 is divided into multiple virtual machines (VMs) 104, 106, and 108 through logical partitioning. In the illustrated example, each of the respective VM's 104, 106, and 108 runs an independent, guest operating system (OS), for example, VM 104 runs an OS 132, which can be the AIX® operating system, VM 106 runs an OS 134, which can be the Virtual Input/Output Server (VIOS), and VM 108 runs an OS 136, which can be the Linux® operating system. Other operating environments and combinations of operating environments may be used. In various embodiments of the present invention, any number of partitions, or virtual machines, may be created and may exist on separate physical computers of a clustered computer system.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between host computing system 102, server computer 160, and other host computing systems that may be located within virtualized computing environment 100.

Communications from network 110 may be routed through Shared Ethernet adapter (SEA) 112 on VM 106 to virtual adapters 114 and 116 on respective VMs 104 and 108. Communications from virtual adapters 114 and 116 on respective VMs 104 and 108 may be routed through SEA 112 on VIOS partition 106 to network 110. In an alternative embodiment, physical network adapters may be allocated to VMs 104, 106, and 108.

Hypervisor 118 forms VMs 104, 106, and 108 from the physical resources of host computing system 102 through logical sharing of designated processors 120, storage disks 122, network cards 124, and/or memory 126 among logical partitions 104, 106, and 108. Hypervisor 118 performs standard operating system functions and manages communication between VMs 104, 106, and 108. Hypervisor 118 of host computing system 102 caches data requested by each virtual machine of the host computing system 102, so the data is available from the hypervisor's cache to all the virtual machines of host computing system 102.

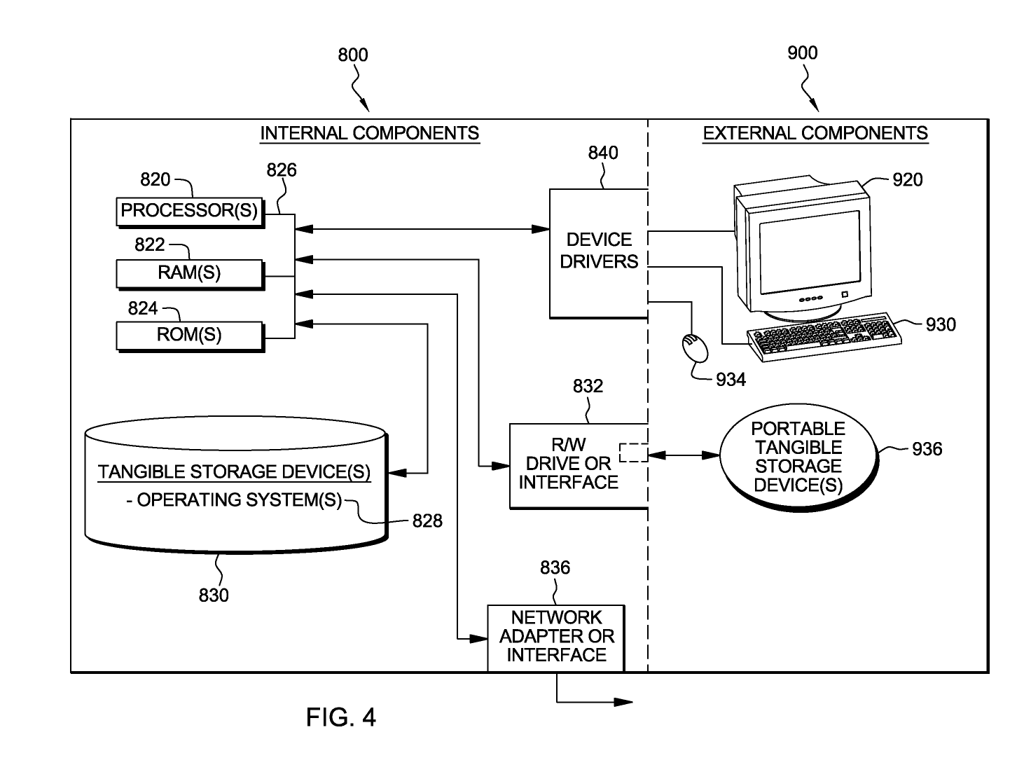

Host computing system 102 includes monitoring component 140 (such as a computer program), which monitors common data accessed by VMs 104, 106, and 108 in shared storage 150. Each host computing system within virtualized computing environment 100 contains a monitoring component 140, which can track the data accessed by VMs located on each host computing system, summarize the access information and report the data accesses to placement manager 162. In an exemplary embodiment, monitoring component 140 monitors data at the block level and tracks accessed data blocks stored in shared storage 150. In various embodiments of the present invention, accessed data blocks are tracked using tracers that are modified to also record content. In accordance with an embodiment of the present invention, virtual machines on different host computing systems that have a history of accessing the same data blocks (as determined from the tracking of data access requests by monitoring component 140) are migrated and grouped together on the same host computing system, to optimize the percentage of cache hits for the data that is cached by the hypervisor of this host computing system, for example, hypervisor 118 on host computing system 102. While in FIG. 1, monitoring component 140 is included, generally, in host computing system 102, one of skill in the art will appreciate that in other embodiments, monitoring component 140 can be located in each VM on a host computing system, including host computing system 102. Host computing system 102 may include internal and external hardware components as depicted and described in further detail with respect to FIG. 4.

Shared storage 150 is a storage device located within virtualized computing environment 100 and can be accessed by host computing systems, such as host computing system 102, and server computer 160 via network 110. Server computer 160 is a dedicated host computer within virtualized computing environment 100 and includes placement manager 162, which runs grouping and migration program 164. Server computer 160 may include internal and external hardware components as depicted and described with respect to FIG. 4.

Placement manager 162 is a centralized VM manager that maintains information such as VM resource allocation information and VM location information. Placement manager 162 also receives information from each hypervisor which reports, for example, network utilization, energy consumption, and CPU consumption, for VMs within virtualized computing environment 100. Grouping and migration program 164 collects information from monitoring component 140 in each host computing system and determines similarities in data accessed in shared storage 150 among VMs in virtualized computing environment 100. Grouping and migration program 164 generates VM groupings based on similarities in accessed data and determines a migration plan, which specifies a host computing system for each VM grouping.

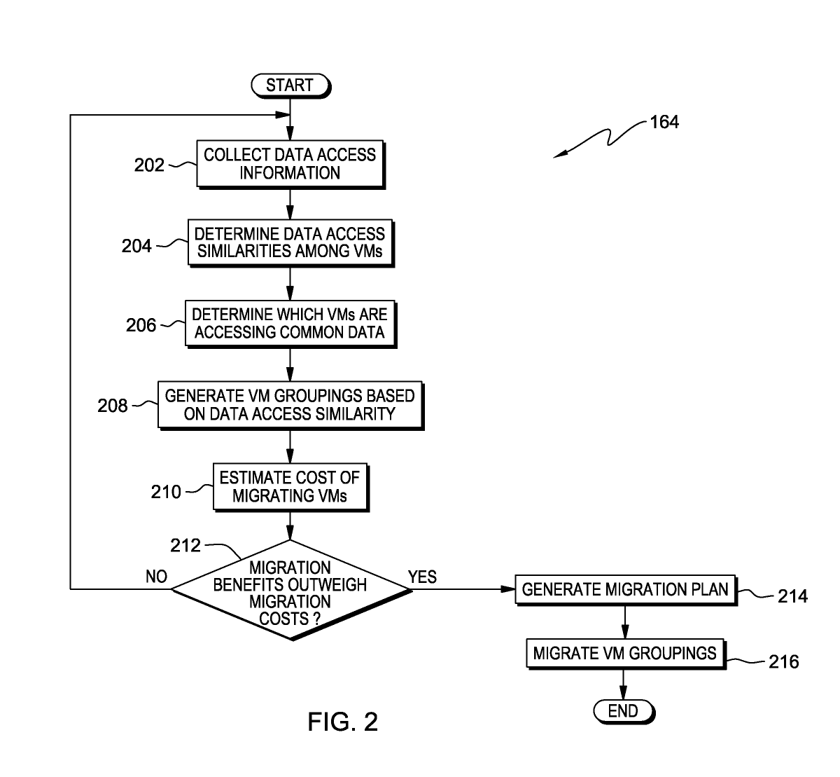

FIG. 2 is a flowchart illustrating operational steps of grouping and migration program 164, residing on server computer 160, for grouping virtual machines and migrating the grouped virtual machines within virtualized computing environment 100, in accordance with an embodiment of the present invention.

Grouping and migration program 164 collects data access information (step 202). In an exemplary embodiment of the present invention, the monitoring component 140 on each host computing system, for example, host computing system 102, monitors the data each VM is accessing that is stored in shared storage 150 and reports the information to centralized placement manager 162. In another exemplary embodiment of the present invention, the monitoring component 140 monitors the data accesses of each VM and reports the access information to a distributed hash table (DHT) component on each host computing system. The DHT component on each host computing system is only responsible for a range of hash values, and the access information is distributed into the DHTs based on the hash value of the accessed blocks. After the access information is processed in DHTs, the DHT on each host computing system will then report the information to centralized placement manager 162. In various embodiments, the reported information can be requested from placement manager 162 by grouping and migration program 164, reported to grouping and migration program 164 by monitoring component 140, or reported to grouping and migration program 164 by the DHT component.

Grouping and migration program 164 determines data access similarities among VMs (step 204) using the information collected from the monitoring component or the DHT component, e.g., which virtual machines have accessed the same data in the past and how often each virtual machine has accessed the same data. In an exemplary embodiment of the present invention, data access similarities between VMs are measured based on a ratio of common data accessed as compared with the total data accessed.

Grouping and migration program 164 uses the ratio to determine which VMs are most frequently accessing common data (step 206) and generates VM groupings based on the data access similarity (step 208). VM groupings consist of one or more VMs, and a grouping can also contain another VM group. In an exemplary embodiment of the present invention, VM groupings are determined using hierarchical clustering. Before hierarchical clustering takes place, each VM is part of a group, or cluster, with only itself as a member, and as grouping and migration program 164 generates VM groupings, VMs are grouped with other VMs into clusters, iteratively, until no more clusters can be determined based on the clustering criteria, for example, data access similarity and resource restrictions.

Grouping and migration program 164 estimates the cost of migrating VMs from a current host computing system to a host computing system containing other VMs in the determined grouping (step 210). Migration costs can include, for example, network distance between VMs and impacts on network traffic. Network distance can refer to requirements to transfer the in-memory data from one host computing system to another. The larger the allocated memory VM groupings have and the longer the distance, the higher network traffic they would incur, thus leading to higher migration costs. In various embodiments, migration costs can be estimated as the smaller of the allocated memory size among two VM groupings times the network distance between the two VM groupings.

Grouping and migration program 164 determines whether estimated migration benefits outweigh estimated migration costs (decision block 212). Migration benefits can be estimated by comparing the data access similarity ratio of each VM grouping that would be migrated. The data access similarity ratio can be, for example, the sum of unique (not common) data blocks accessed by each VM in a VM grouping subtracted by the total number of data blocks accessed by the VM grouping. Migration costs can be estimated as described above using the network distance between and the allocated memories of each VM grouping to be migrated. If the migration benefits do not outweigh costs (decision block 212, no branch), grouping and migration program 164 returns to collect data access information.

If the migration benefits do outweigh migration costs (decision block 212, yes branch), grouping and migration program 164 generates a migration plan (step 214). The migration plan specifies a host computing system for each VM grouping with the aim to place an entire grouping on one host computing system, and to minimize the number of migrations, time and network traffic in migrating each VM grouping to the specified host computing system. In various embodiments, grouping and migration program 164 may generate more groupings than host computing systems, and therefore multiple groupings may share a host.

Grouping and migration program 164 migrates the VM groupings (step 216). In various embodiments of the present invention, the migration plan may call for some VMs to remain on a current host computing system.

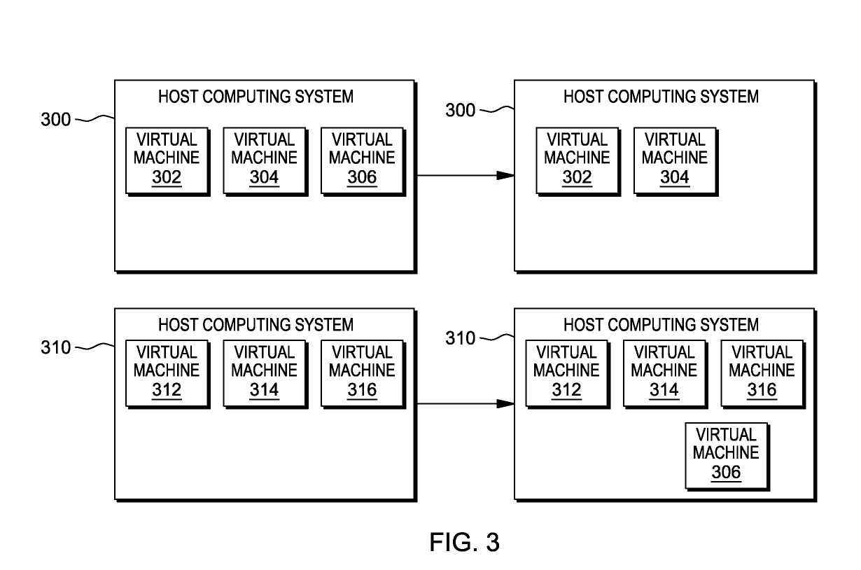

FIG. 3 depicts migration of VMs within virtualized computing environment 100 based on operation of grouping and migration program 164, in accordance with an embodiment of the present invention. Host computing system 300 and 310 are representative of physical computing systems located within, for example, virtualized computing environment 100. Prior to operation of grouping and migration program 164, host computing system 300 includes VMs 302, 304, and 306. Host computing system 310 includes VMs 312, 314, and 316. Grouping and migration program 164 determines that VM 306 is accessing many common data blocks in shared storage, for example, shared storage 150, as VMs 312, 314, and 316 when performing received workload requests. Grouping and migration program 164 may determine a VM grouping, based on similarity between data accessed, that includes VM 306, and VMs 312, 314, and 316. If grouping and migration program 164 determines the migration benefits outweigh the migration costs, the determined VM grouping is migrated to host computing system 310, while VMs 302 and 304 remain on host computing system 300.

FIG. 4 depicts a block diagram of internal components 800 and external components 900 of host computing system 102 or server computer 160 of FIG. 1, in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Host computing system 102 or server computer 160 are representative of any electronic device capable of executing machine-readable program instructions, for example, notebook computers, tablet computers, personal computer (PC) systems, thin clients, thick clients, hand-held, laptop or smart-phone devices, multiprocessor systems, microprocessor-based systems, network PCs, minicomputer systems, and distributed cloud computing environments that include any of the above systems or devices.

Host computing system 102 and server computer 160 include both internal components 800 and external components 900, illustrated in FIG. 4. Internal components 800 include one or more processors 820, one or more computer-readable RAMs 822 and one or more computer-readable ROMs 824 on one or more buses 826, one or more operating systems 828 and one or more computer-readable tangible storage devices 830. The one or more operating systems 828 and hypervisor 118 on host computing system 102 and grouping and migration program 164 on server computer 160 are stored on one or more of the respective computer-readable tangible storage devices 830 for execution by one or more of the respective processors 820 via one or more of the respective RAMs 822 (which typically include cache memory). In the illustrated embodiment, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store but does not transmit a computer program and digital information.

Each set of internal components 800 also includes a R/W drive or interface 832 to read from and write to one or more portable computer-readable tangible storage devices 936 that can store but do not transmit a computer program, such as a CD-ROM, DVD, memory stick, magnetic tape, magnetic disk, optical disk or semiconductor storage device. Hypervisor 118 on host computing system 102 and grouping and migration program 164 on server computer 160 can be stored on one or more of the respective portable computer-readable tangible storage devices 936, read via the respective R/W drive or interface 832 and loaded into the respective hard drive or semiconductor storage device 830.

Each set of internal components 800 also includes a network adapter or interface 836 such as a TCP/IP adapter card or wireless communication adapter (such as a 4G wireless communication adapter using OFDMA technology). Hypervisor 118 on host computing system 102 and grouping and migration program 164 on server computer 160 can be downloaded to the respective computing/processing devices from an external computer or external storage device via a network (for example, the Internet, a local area network or other, wide area network or wireless network) and network adapter or interface 836. From the network adapter or interface 836, the programs are loaded into the respective hard drive or semiconductor storage device 830. The network may comprise copper wires, optical fibers, wireless transmission, routers, firewalls, switches, gateway computers and/or edge servers.

Each of the sets of external components 900 can include a computer display screen 920, a keyboard or keypad 930, and a computer mouse or touchpad 934. External components 900 can also include touch screens, virtual keyboards, touch pads, pointing devices, and other human interface devices. Computer display 920 can be an incorporated display screen, such as is used in tablet computers or smart phones. Each of the sets of internal components 800 also includes device drivers 840 to interface to display screen 920 for imaging, to keyboard or keypad 930, to computer mouse or touchpad 934, and/or to display screen for pressure sensing of alphanumeric character entry and user selections. The device drivers 840, R/W drive or interface 832 and network adapter or interface 836 comprise hardware and software (stored in storage device 830 and/or ROM 824).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The aforementioned programs can be written in any combination of one or more programming languages (such as Java®, C, and C++) including low-level, high-level, object-oriented or non object-oriented languages. Alternatively, the functions of the programs can be implemented in whole or in part by computer circuits and other hardware (not shown). The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature. Numerous modifications and substitutions can be made without deviating from the scope of the present invention. Therefore, the present invention has been disclosed by way of example and not limitation.

What is claimed is:

1. A method for determining that first and second virtual machines, that currently execute in first and second host computing systems, respectively, should both execute within a same host computing system, the method comprising the steps of:
determining, by one or more computer processors, that the first and second virtual machines have accessed same data more often than a third and fourth virtual machines have accessed said same data, and based in part on the determination, determining that the first and second virtual machines should execute in a same host computing system having a same cache memory for both the first and second virtual machines and that the third and fourth virtual machines should execute on one or more different host computing systems than said same host computing system.

2. The method of claim 1, further comprising the step of migrating one or both of the first and second virtual machines to execute in said same host computing system.

3. The method of claim 2, wherein the step of migrating one or both of the first and second virtual machines to execute in said same host computing system further comprises:
determining, by one or more computer processors, said same host computing system has resources sufficient to host both of the first and second virtual machines;
determining, by one or more computer processors, a cost of moving one or both of the first and second virtual machines;
determining, by one or more computer processors, a benefit of moving one or both of the first and second virtual machines; and
determining, by one or more computer processors, the cost of moving one or both of the first and second virtual machines is not more than the benefit of moving one or both of the first and second virtual machines to said same host computing system within the virtualized computing environment.

4. The method of claim 3, wherein the determined resources include at least one of: computing resources, processing resources, network resources and memory resources.

5. The method of claim 3, wherein the cost includes a measure of at least one of: network traffic, resource usage, memory required or overall performance of the virtualized computing environment.

6. The method of claim 3, wherein the benefit includes a comparison of the data accessed by each of the first and second virtual machines.

7. The method of claim 1, further comprising:
determining, by one or more computer processors, that at least one additional virtual machine has accessed said same data;
determining, by one or more computer processors, a data access similarity for the first virtual machine, the second virtual machine and the at least one additional virtual machine, wherein the data access similarity is a ratio of common data accessed as compared with total data accessed; and
determining, by one or more computer processors, based on the data access similarity for each virtual machine, the first, second and at least one additional virtual machine should execute in said same host computing system.

8. A computer program product for determining that first and second virtual machines, that currently execute in first and second host computing systems, respectively, should both execute within a same host computing system, the computer program product comprising:
one or more computer-readable tangible storage media and program instructions stored on the one or more computer-readable tangible storage media, the program instructions comprising:
program instructions to determine that the first and second virtual machines have accessed same data more often than a third and fourth virtual machines have accessed said same data, and based in part on the determination, determining that the first and second virtual machines should execute in a same host computing system having a same cache memory for both the first and second virtual machines and that the third and fourth virtual machines should execute on one or more different host computing systems than said same host computing system.

9. The computer program product of claim 8, further comprising program instructions to migrate one or both of the first and second virtual machines to execute in said same host computing system.

10. The computer program product of claim 9, wherein the program instructions to migrate one or both of the first and second virtual machines to execute in said same host computing system further comprise:
program instructions to determine said same host computing system has resources sufficient to host both of the first and second virtual machines;
program instructions to determine a cost of moving one or both of the first and second virtual machines;
program instructions to determine a benefit of moving one or both of the first and second virtual machines; and
program instructions to determine the cost of moving one or both of the first and second virtual machines is not more than the benefit of moving one or both of the first and second virtual machines to said same host computing system within the virtualized computing environment.

11. The computer program product of claim 10, wherein the determined resources include at least one of: computing resources, processing resources, network resources and memory resources.

12. The computer program product of claim 10, wherein the cost includes a measure of at least one of: network traffic, resource usage, memory required or overall performance of the virtualized computing environment.

13. The computer program product of claim 10, wherein the benefit includes a comparison of the data accessed by each of the virtual machines in the group of virtual machines.

14. The computer program product of claim 8, further comprising:
program instructions to determine that at least one additional virtual machine has accessed said same data;
program instructions to determine a data access similarity for the first virtual machine, the second virtual machine and the at least one additional virtual machine, wherein the data access similarity is a ratio of common data accessed as compared with total data accessed; and
program instructions to determine, based on the data access similarity for each virtual machine, the first, second and at least one additional virtual machine should execute in said same host computing system.

15. A computer system for determining that first and second virtual machines, that currently execute in first and second host computing systems, respectively, should both execute within a same host computing system, the computer system comprising:
one or more computer processors;
one or more computer-readable tangible storage media;
program instructions stored on the one or more computer-readable tangible storage media for execution by at least one of the one or more computer processors, the program instructions comprising:
program instructions to determine that the first and second virtual machines have accessed same data more often than a third and fourth virtual machines have accessed said same data, and based in part on the determination, determining that the first and second virtual machines should execute in a same host computing system having a same cache memory for both the first and second virtual machines and that the third and fourth virtual machines should execute on one or more different host computing systems than said same host computing system.

16. The computer system of claim 15, further comprising program instructions to migrate one or both of the first and second virtual machines to execute in said same host computing system.

17. The computer system of claim 16, wherein the program instructions to migrate one or both of the first and second virtual machines to execute in said same host computing system further comprise:
program instructions to determine said same host computing system has resources sufficient to host both of the first and second virtual machines;
program instructions to determine a cost of moving one or both of the first and second virtual machines;
program instructions to determine a benefit of moving one or both of the first and second virtual machines; and
program instructions to determine the cost of moving one or both of the first and second virtual machines is not more than the benefit of moving one or both of the first and second virtual machines to said same host computing system within the virtualized computing environment.

18. The computer system of claim 17, wherein the determined resources include at least one of: computing resources, processing resources, network resources and memory resources.

19. The computer system of claim 17, wherein the cost includes a measure of at least one of: network traffic, resource usage, memory required or overall performance of the virtualized computing environment.

20. The computer system of claim 17, wherein the benefit includes a comparison of the data accessed by each of the virtual machines in the group of virtual machines.

21. The computer system of claim 15, further comprising:
program instructions to determine that at least one additional virtual machine has accessed said same data;
program instructions to determine a data access similarity for the first virtual machine, the second virtual machine and the at least one additional virtual machine, wherein the data access similarity is a ratio of common data accessed as compared with total data accessed; and
program instructions to determine, based on the data access similarity for each virtual machine, the first, second and at least one additional virtual machine should execute in said same host computing system.
